(19) United States
(12) Patent Application Publication
(10) Pub. No.: US 2015/0077994 A1
(43) Pub. Date: Mar. 19, 2015

(54) STRUCTURE OF LED LIGHT

(71) Applicant: TAI MING GREEN POWER CO., LTD., New Taipei City (TW)

(72) Inventors: CHIA-CHEN WANG, New Taipei City (TW); HUNG-KUANG YANG, New Taipei City (TW)

(73) Assignee: TAI MING GREEN POWER CO., LTD., New Taipei City (TW)

(21) Appl. No.: 14/027,250

(22) Filed: Sep. 16, 2013

(51) Int. Cl. F21V 29/00; F21V 7/10; F21K 99/00

(52) U.S. Cl. CPC F21V 29/2206; F21K 9/50; F21V 7/10
USPC 362/241

(57) ABSTRACT

An improved structure of an LED light includes a light source module and a heat dissipation module. The light source module includes a plurality the compartments formed therein and each of the compartments receives therein a light reflector and a light emission element. The compartments are provided with a seat at an end thereof distant from the light emission elements. Each of the compartments is provided with a cover mounted thereon. The heat dissipation module has an outer wall forming a heat dissipation fin section. The heat dissipation module receives therein a drive module electrically connected to the light emission element. The heat dissipation module is coupled to the seat. With such an arrangement, the loss of light is minimized to achieve optimum utilization. The heat dissipation module is kept away from the light source module so that excellent effect of heat dissipation can be achieved.

### TECHNICAL FIELD OF INVENTION

The present invention generally relates to a structure of an illuminating light in which a light source and a heat dissipation mechanism are separated, and more particularly to an improved structure of an LED light that shows a high efficiency of light utilization and a high efficiency of heat dissipation.

### DESCRIPTION OF THE PRIOR ART

The discovery and use of light imposes a tremendous influence on human history of civilization. From early days when a burning fire was used for lighting to the state-of-the-art technology of LED, all are provided for lighting and to improve living quality of human beings.

The contemporary lighting technology, either LED or other different types of lighting components, electrical power from an electric main must be converted into a standard that is usable for the lighting components. During the operation, the drive module that carries out conversion of electrical power and the lighting elements both generate waste heat. Further, in the current designs of lights, the drive module and the lighting component are often arranged adjacent to each other. Such an arrangement generally leads to mutual influence of the heats generated thereby, making the overall temperature excessively increased and dissipation of heat difficult. When put in operation in such a high temperature in an extended period of time, the lights may get damaged.

Further, light utilization efficiency is also an important topic. Most of the conventional lighting devices are arranged to provide a heat dissipating coating on a surface thereof. This arrangement is made to improve the issue of heat dissipation. However, this arrangement causes another problem, which is a problem associated with light utilization efficiency. Thus, the conventional lighting devices cannot simultaneously achieve the purposes of optimizing light utilization efficiency and optimizing the result of heat dissipation.

Thus, it is a challenge of the present inventor and the manufacturers of the industry to overcome the above discussed problems.

### SUMMARY OF THE INVENTION

In view of the above drawbacks, the present invention aims to provide an improved structure of an LED light that features high light utilization efficiency and high heat dissipation efficiency.

The primary object of the present invention is to arrange a light source module and a heat dissipation module to be spaced from each other with contact being made therebetween at a single end. As such, components that generate heat internally are kept from each other by a predetermined distance to provide an excellent heat dissipation environment. Further, with a collaborative arrangement of a light reflector and a light emission element, the utilization of light is optimized. With such a technique, the problems of the conventional lighting device that the generated waste heats may affect each other and thus result in a poor heat dissipation environment and the efficiency of light utilization is poor can be overcome to achieve the practical advantages of high efficiency of light utilization and high efficiency of heat dissipation.

To achieve the above object, the present invention comprises a light source module and a heat dissipation module. The light source module comprises a plurality of compartments formed therein. Each of the compartments receives a light reflector and a light emission element mounted therein. The compartments are provided, at an end distant from the light emission elements, with a seat. Each of the compartments is provided with a cover. Further, the heat dissipation module has an outer wall that forms a heat dissipation fin section. The heat dissipation module receives therein a drive module electrically connected to the light emission elements. The seat of the light source module is coupled to the heat dissipation module.

With such an arrangement, when the drive module is supplied with electrical power and set into operation, the light emission element immediately operates and gives off light. The heat emitting from the drive module is primarily dissipated through the heat dissipation fin section to avoid accumulation of the heat and thus maintaining an excellent condition of the operation environment. Most of the light generated by the light emission element is projected out in a manner of normal incidence and remaining light scattered in other directions is collected and outward projected again with the assistance of the configuration of the compartments and the arrangement of the light reflectors. Thus, the light can be utilized with the most efficient manner to achieve the best utilization efficiency to thereby realize the practical advantages of high efficiency of light utilization and high efficiency of heat dissipation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment according to the present invention.

FIG. 2 is an exploded view of the preferred embodiment of the present invention.

FIG. 3 is another exploded view of the preferred embodiment of the present invention.

FIG. 4 is a schematic view showing the structure of the preferred embodiment of the present invention.

FIG. 4A is partial schematic view of the preferred embodiment of the present invention.

FIG. 5 is a schematic view illustrating light illumination of the preferred embodiment of the present invention.

FIG. 6 is a schematic view illustrating heat dissipation of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

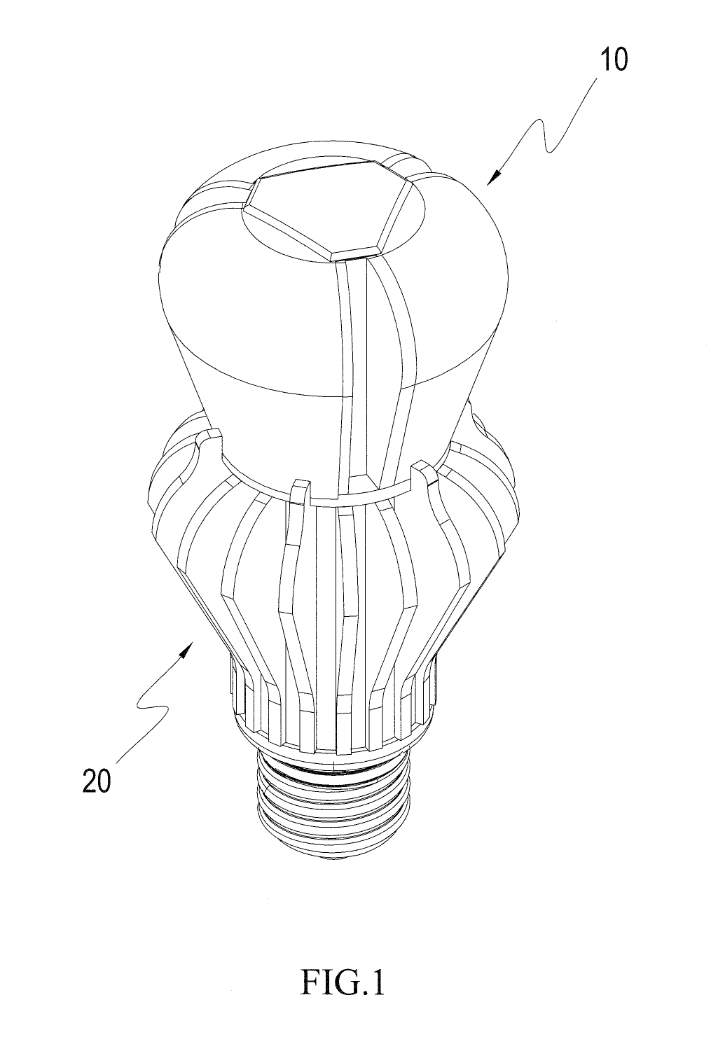

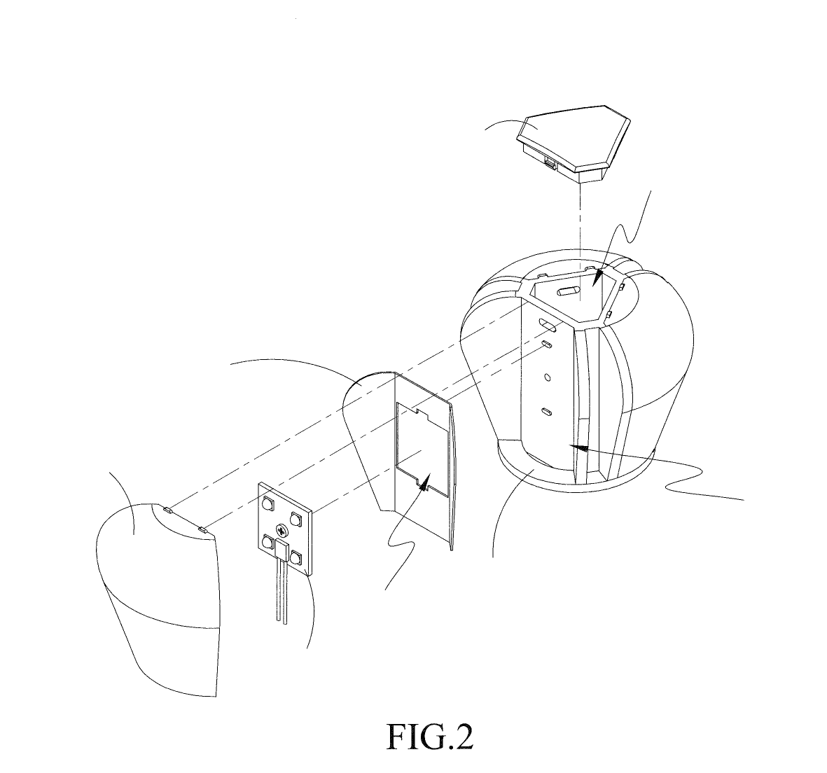

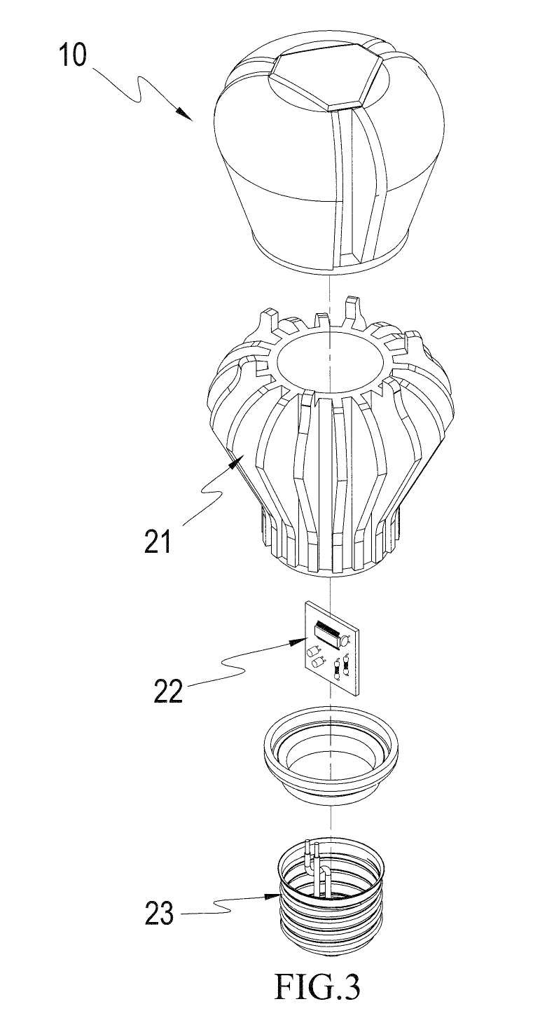

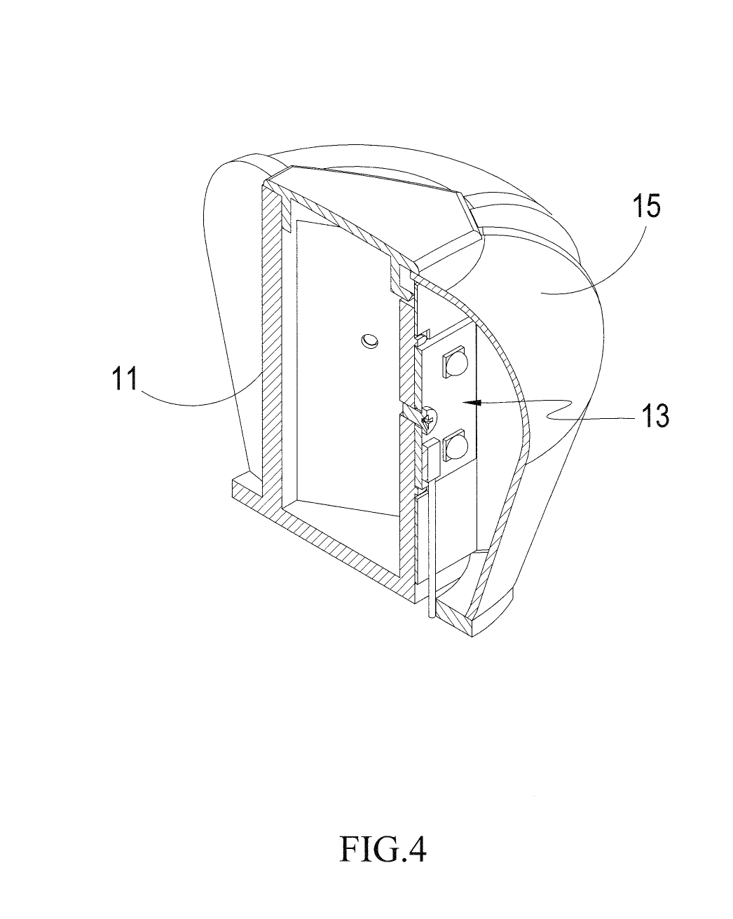

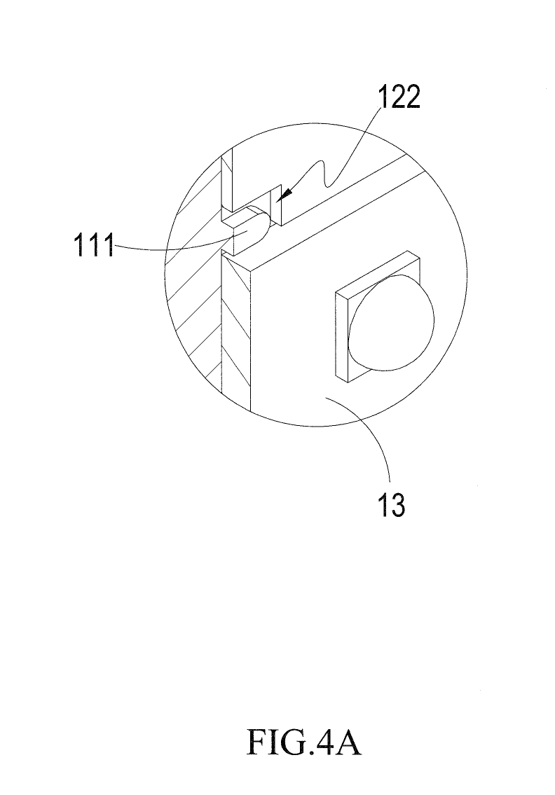

Referring to FIGS. 1, 2, 3, 4, 4A, 5, and 6, which are respectively a perspective view, an exploded view, another exploded view, a schematic view, and a partial schematic view of a preferred embodiment of the present invention and a schematic view illustrating light illumination of the preferred embodiment of the present invention and a schematic view illustrating heat dissipation of the preferred embodiment of the present invention, these drawings clearly show that the present invention comprises the following constituent components:

A light source module 10 comprises a plurality of compartments 11 formed therein. Each of the compartments 11 receives a light reflector 12 and a light emission element 13 mounted therein. The compartments 11 are provided, at an end distant from the light emission elements 13, with a seat 14. Each of the compartments 11 is provided with a cover 15.

A heat dissipation module 20 is coupled to the seat 14. The heat dissipation module 20 has an outer wall that forms a heat dissipation fin section 21. The heat dissipation module 20 receives therein a drive module 22 electrically connected to the light emission elements 13.

The light source module 10 comprises a bore 16 formed therein. The bore 16 is provided with a corresponding lid 17 thereon. The light reflectors 12 have a shape corresponding and mating the shape of the compartments 11. Each of the light reflectors 12 comprises an opening 121 formed therein and the light emission element 13 is mounted in the opening 121. The compartments 11 form a plurality of retention tenons 111 and the openings 121 comprise retention mortises 122 mating the retention tenons 111.

The covers 15 are made of a light-transmitting material. The light emission elements 13 comprise a light-emitting diode. The heat dissipation module 20 comprises an electrical conduction section 23. The electrical conduction section 23 is electrically connected to the drive module 22 and the electrical conduction section 23 is set at the end of the heat dissipation module that is distant from the seat 14.

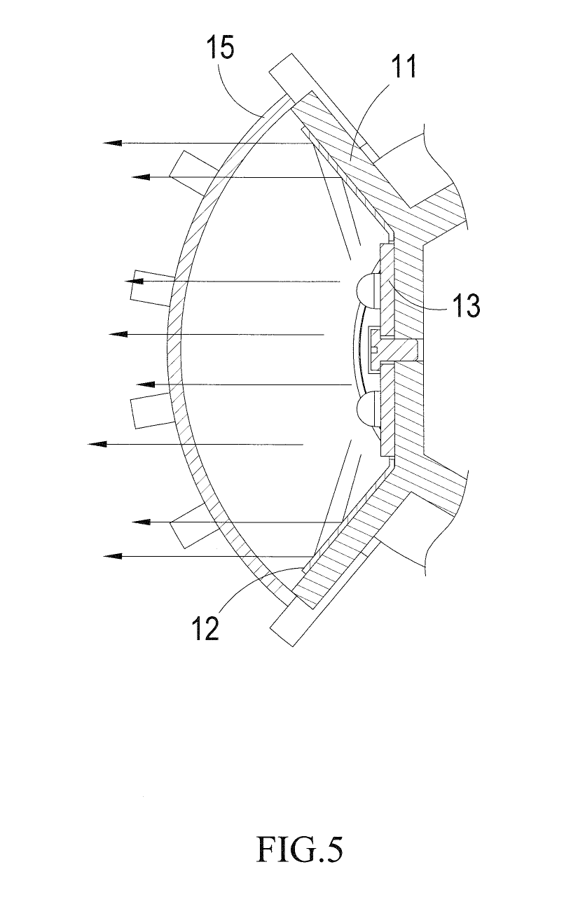

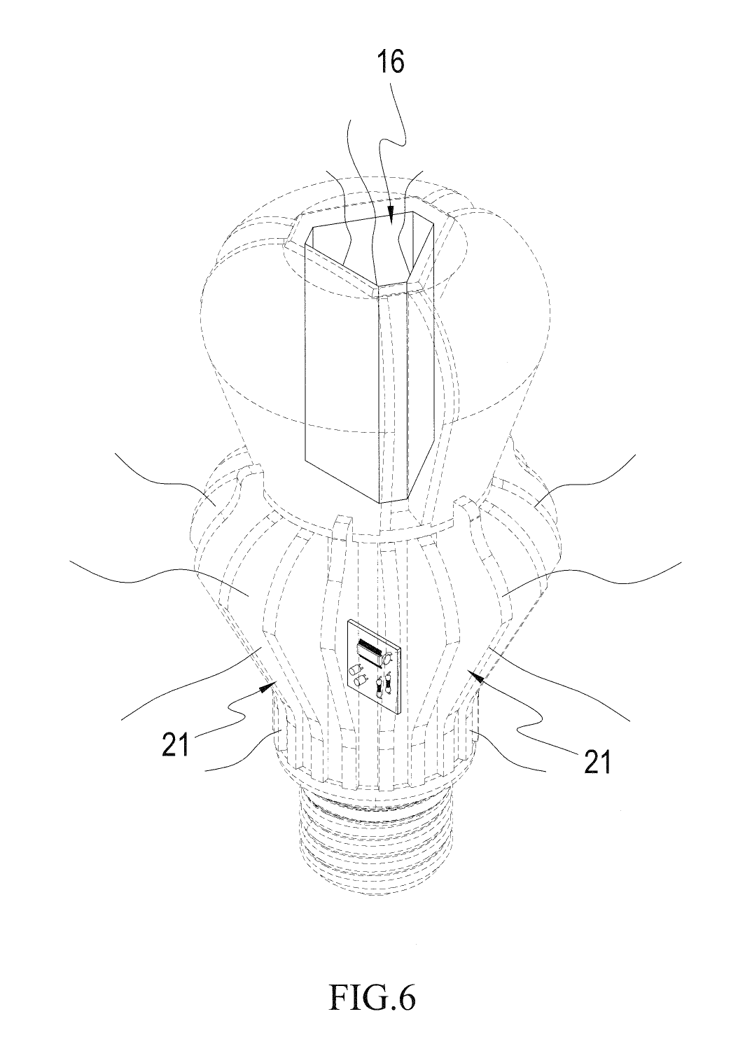

Based on the above-described structure, the following description will be given to help understanding of the technical features of the present invention. Referring to FIGS. 1-4, a description of the light structure and the assembling structure of the present invention will be made, which is generally composed of two major modules, namely the light source module 10 and the heat dissipation module 20. In the instant embodiment, the light source module 10 comprises three compartments 11. To mount the light reflectors 12 to the compartments 11, the retention tenons 111 are set to mate the retention mortises 122 and the covers 15 are fit into the compartments 11, whereby the assembling efficient and convenient and simplification of the manufacturing flow can be achieved. Referring to FIGS. 5 and 6, to use, the electrical conduction section 23 is coupled to a corresponding socket to establish electrical connection therebetween. During the supply of electrical power, the light emission elements 13 that are included in the light source module 10 and the drive module 22 that is mounted in the heat dissipation module 20 are kept from each other by a predetermined distance so that the heats generated thereby do not affect each other. Further, the heat of the drive module 22 is efficiently conducted out through the heat dissipation fin section 21 so that the heat dissipation module 20, in entirety, may maintain an excellent heat dissipation environment. Further, heat is also conducted out through the bore 16 to provide chimney effect based heat dissipation. As such, the whole device can be maintained in an excellent operation temperature, suppressing light attenuation and reduction of lifespan caused by over-heating and also achieving optimization of heat dissipation. As to illumination, since the light emission elements 13 are mounted in the openings 121 of the light reflectors 12, when the light emission elements 13 give off light, most of the light transmits through the cover 15 in a manner of normal incidence and the remaining scattered light is incident onto the light reflectors 12 of high reflectivity and reflected again thereby to transmit through the cover 15. With the arrangement of the light reflector 12, an optimum result of use can be achieved for generation and utilization of light and the device, as a whole, provides extraordinary performance to achieve practical advantages of high light utilization efficiency and high heat dissipation efficiency.

Thus, the present invention provides an improved structure of an LED light that provides the following key techniques for improving the known technique:

(1) The light source module 10 and the heat dissipation module 20 are kept from each other by a predetermined distance so that the heat sources do not affect each other and thus, an excellent operation environment can be maintained to achieve an advantage of high heat dissipation efficiency.

(2) The light emission elements 13 are used in combination with the light reflectors 12 to allow scattered light to be used again so as to realize the optimum use of the light and thus achieving an advantage of high efficiency of light utilization. Further, the design of the cover 15 helps control the projection direction of the light.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An LED light, comprising:
a light source module, which comprises a plurality of compartments formed therein, each of the compartments receiving a light reflector and a light emission element mounted therein, the compartments being provided, at an end distant from the light emission elements, with a seat, each of the compartments being provided with a cover; and
a heat dissipation module, which is coupled to the seat, the heat dissipation module having an outer wall that forms a heat dissipation fin section, the heat dissipation module receiving therein a drive module electrically connected to the light emission elements.

2. The LED light according to claim 1, wherein the light source module comprises a bore formed therein, the bore being provided with a lid set thereon.

3. The LED light according to claim 1, wherein the light reflectors have a shape corresponding and mating shape of the compartments, each of the light reflectors comprising an opening formed therein so that the light emission element is mounted in the opening.

4. The LED light according to claim 3, wherein the compartments form a plurality of retention tenons and the openings comprise retention mortises engageable with the retention tenons.

5. The LED light according to claim 1, wherein the covers are made of a light-transmitting material.

6. The LED light according to claim 1, wherein the light emission elements comprises a light-emitting diode.

7. The LED light according to claim 1, wherein the heat dissipation module comprises an electrical conduction section, he electrical conduction section being electrically connected to the drive module, the electrical conduction section being set at an end of the heat dissipation module that is distant from the seat.
